(19) United States
(12) Patent Application Publication
(10) Pub. No.: US 2021/0028532 A1
(43) Pub. Date: Jan. 28, 2021

(54) Picture frame structure for supporting wireless network communication

(71) Applicant: Chung-Ping LAI, Hsinchu County (TW)

(72) Inventor: Chung-Ping LAI, Hsinchu County (TW)

(21) Appl. No.: 16/522,644

(22) Filed: Jul. 26, 2019

(51) Int. Cl. H01Q 1/22; H01Q 1/36; A47G 1/06

(52) U.S. Cl. CPC H01Q 1/22; A47G 1/06; H01Q 1/364

(57) ABSTRACT

A picture frame structure contains: a protective frame, a canvas fixed on the protective frame, an antenna, and an wireless communication module. The antenna is made of conductive material and is printed on the canvas, and the conductive material of the antenna penetrates into the canvas. The wireless communication module and the antenna are connected so as to wirelessly communicate with the antenna.

### FIELD OF THE INVENTION

The present invention relates to a picture frame structure for supporting wireless network communication.

### BACKGROUND OF THE INVENTION

A combination of a RFID antenna and an illumination device is disclosed in U.S. Pat. No. 10,210,355B1 and contains: a casing, a lighting unit, and a RFID antenna.

The casing includes a metal plate and a fixing frame which has an opening and being mounted on a front end of the metal plate. The lighting unit includes a light guide plate and multiple light emitting elements, wherein the lighting unit is defined between the metal plate and the fixing frame, the light guide plate is fixed between the metal plate and the fixing frame, and the light guide plate has a transporting face facing the opening of the fixing frame so that the lights illuminate to the transporting face of the light guide plate from the multiple light emitting element. The RFID antenna is accommodated in the front end of the metal plate and is defined between the light guide plate and the metal plate.

The present invention has arisen to mitigate and/or obviate the afore-described disadvantages.

### SUMMARY OF THE INVENTION

The primary objective of the present invention is to provide a picture frame structure for supporting wireless network communication.

To obtain above-mentioned objective, a picture frame structure for supporting wireless network communication provided by the present invention contains: a protective frame, a canvas fixed on the protective frame, an antenna, and an wireless communication module.

The antenna is made of conductive material and is printed on the canvas, and the conductive material of the antenna penetrates into the canvas.

The wireless communication module and the antenna are connected so as to wirelessly communicate with the antenna.

Preferably, the wireless communication module is any one of an access point (AP) Wi-Fi module, a router Wi-Fi module, a Bluetooth module, radio frequency identification (RFID) reader, a radio frequency identification (RFID) tag module, and a mobile communication module.

Preferably, the antenna is printed on a back face of the canvas.

Preferably, the wireless communication module is mounted on a groove of a back surface of the protective frame.

Preferably, the wireless communication module is connected with the antenna via a wire.

Preferably, the protective frame includes a contacting plate located on a back surface of the canvas, and the antenna is defined between the back face of the canvas and the contacting plate.

Preferably, the contacting plate has a window, and the wireless communication module is connected with the antenna by using a wire passing through the window and the antenna.

Preferably, the antenna includes a first surround portion printed on a back face of the canvas, and the wireless communication module includes a second surround portion stacked and coupled with the first surround portion.

Preferably, a height difference is defined between the contacting plate and the protective frame, wherein the contacting plate has an accommodation space for accommodating the wireless communication module upside down, wherein the wireless communication module is a desktop device.

Preferably, the canvas has a first layer on a front side of the first face, and the canvas has a second layer attached on a back side of the first layer, the antenna is printed on the back side of the first layer and between the first layer and the second layer.

Preferably, the canvas has an opening formed on the second layer so that the wireless communication module is connected with the antenna by using a wire passing through the opening and the antenna.

Preferably, the antenna includes a first surround portion, and the wireless communication module includes a second surround portion stacked and coupled with the first surround portion.

### BRIEF DESCRIPTION OF THE DRAWINGS

FIG. 1 is a perspective view showing the exploded components of a picture frame structure for supporting wireless network communication according to a preferred embodiment of the present invention.

FIG. 2 is a cross sectional view showing the assembly of the picture frame structure for supporting wireless network communication according to the preferred embodiment of the present invention.

FIG. 3 is a side plan view showing the operation of the picture frame structure for supporting wireless network communication according to the preferred embodiment of the present invention.

FIG. 4 is another side plan view showing the operation of the picture frame structure for supporting wireless network communication according to the preferred embodiment of the present invention.

FIG. 5 is a cross sectional view showing the assembly of a part of the picture frame structure for supporting wireless network communication according to the preferred embodiment of the present invention.

FIG. 6 is a cross sectional view showing the assembly of a part of a picture frame structure for supporting wireless network communication according to another preferred embodiment of the present invention.

FIG. 7 is another cross sectional view showing the assembly of a part of the picture frame structure for supporting wireless network communication according to another preferred embodiment of the present invention.

FIG. 8 is a cross sectional view showing the assembly of a part of the picture frame structure for supporting wireless network communication according to another preferred embodiment of the present invention.

FIG. 9 is a side plane view showing the assembly of the picture frame structure for supporting wireless network communication according to the preferred embodiment of the present invention.

FIG. 10 is a cross sectional view showing the assembly of a picture frame structure for supporting wireless network communication according to another preferred embodiment of the present invention.

FIG. 11 is a cross sectional view showing the assembly of a part of the picture frame structure for supporting wireless network communication according to another preferred embodiment of the present invention.

FIG. 12 is a cross sectional view showing the assembly of a part of a picture frame structure for supporting wireless network communication according to another preferred embodiment of the present invention.

FIG. 13 is a cross sectional view showing the assembly of a part of a picture frame structure for supporting wireless network communication according to another preferred embodiment of the present invention.

### DETAILED DESCRIPTION OF THE PREFERRED EMBODIMENTS

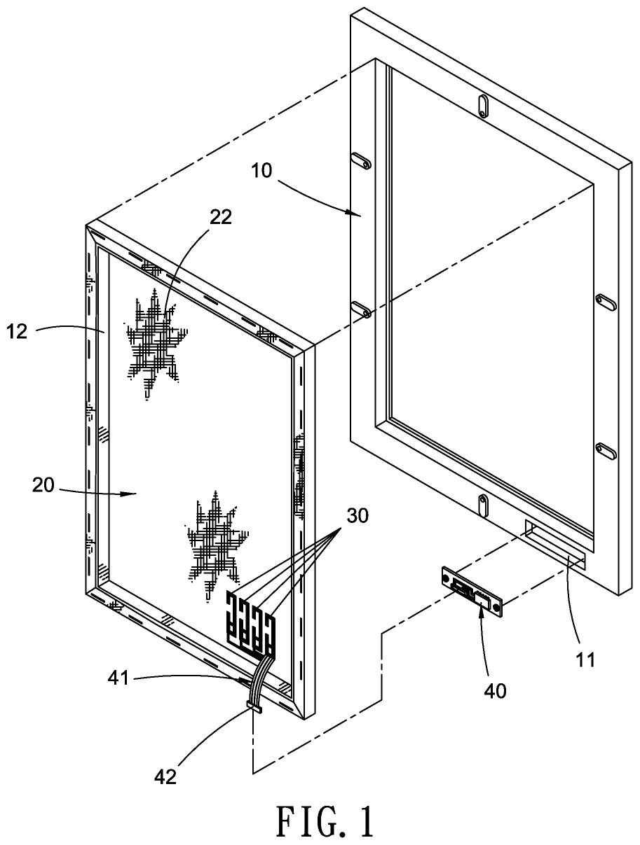

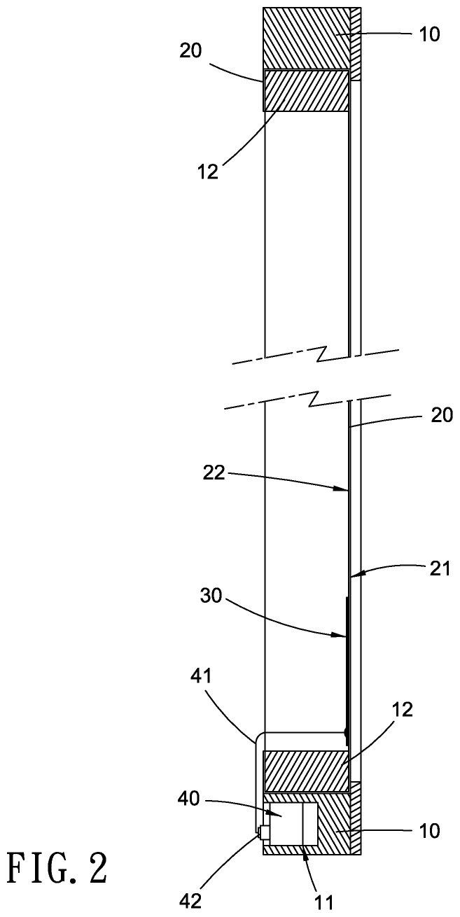

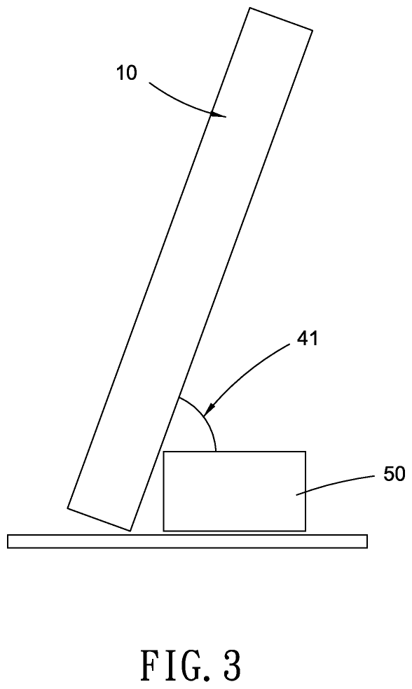

With reference to FIGS. 1 and 2, a picture frame structure for supporting wireless network communication according to a preferred embodiment of the present invention comprises: a protective frame 10, a canvas 20, an antenna 30, and a wireless communication module 40.

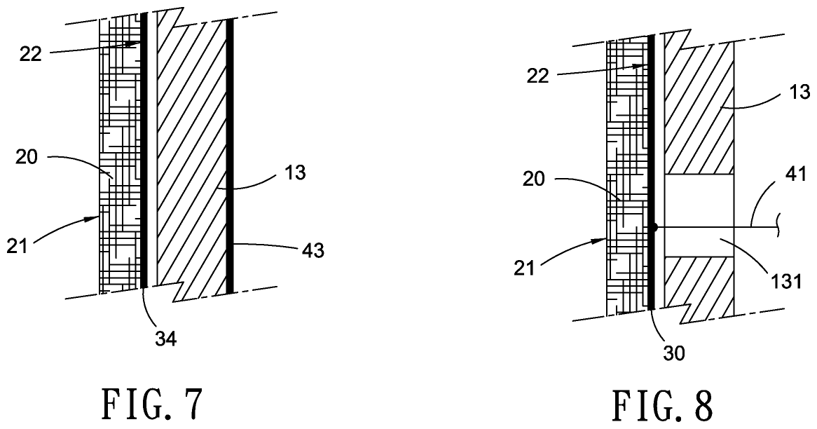

The protective frame 10 is hollow (in a normal state, the protective frame is hollowly rectangular), the canvas 20 is expanded and is fixed on the protective frame 10 or on a support 12 of the protective frame 10, wherein a first face 21 of the canvas 20 is configured to be drawn or printed, wherein the antenna 30 is connected on a back face 22 of the canvas 20, the wireless communication module 40 and the antenna 30 are connected directly or indirectly, and the wireless communication module 40 wirelessly communicates with the antenna 30. Referring to FIGS. 7 and 8, in another embodiment, the protective frame 10 includes a contacting plate 13 located on a back surface of the canvas 20, and the antenna 30 is defined between the back face 22 of the canvas 20 and the contacting plate 13.

The antenna 30 is made of conductive material and is printed on the back face 22 of the canvas 20, the canvas 20 is made of cloth or paper, and the conductive material of the antenna 30 penetrates into the canvas 20. The conductive material of the antenna 30 is disclosed in U.S. Pat. No. 10,233,346B2, an inventor of which is the same as the present invention. For example, the conductive material is binder-free composite consisting of 10 wt % to 60 wt % of metal powders, 5 wt % to 20 wt % of carbon powders, at least one dispersant occupying 0.01 wt % to 0.1 wt % of the binder-free composite, and at least one solvent occupying 30 wt % to 75 wt % of the binder-free composite.

The metal powders are any one of gold, silver, copper, cobalt, nickel, zinc, alloy of the gold, the silver, the copper, the cobalt, the nickel and the zinc, core shell or granules coated by the sliver, wherein a size of the granules is 10 nm to 100 μm, wherein the metal powders are flaky, granular, columnar or linear.

The carbon powders are at least one of graphene, graphite, carbon black, and carbon nanotubes, wherein a thickness of the carbon powders is 1 nm to 10000 nm, and a size of the carbon powders is 0.1 μm to 100 μm. Accordingly, the conductive material of the antenna 30 penetrates into and attached on the canvas 20.

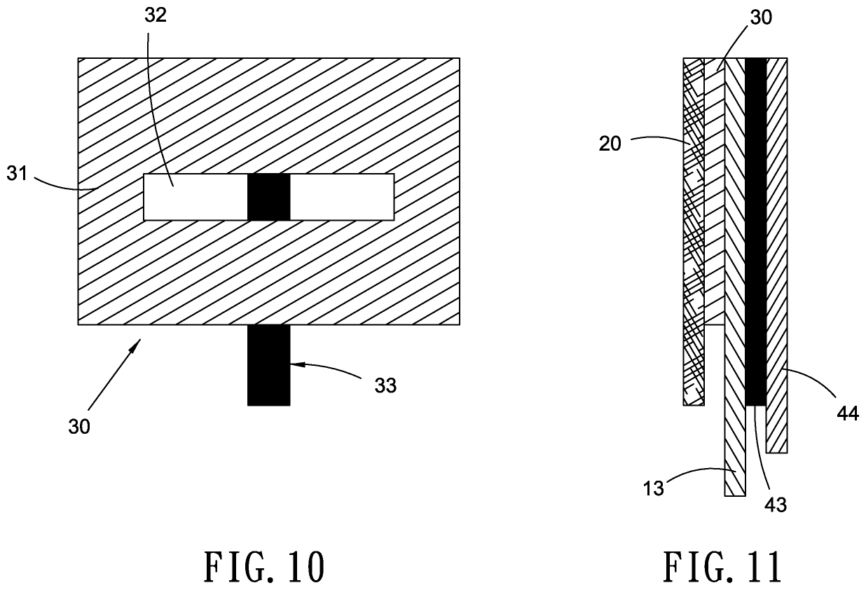

In another embodiment, after the antenna 30 is printed on a side of a substrate (such as plastic substrate), the antenna 30 is connected with the back face 22 of the canvas 20. The antenna 30 is a panel antenna as shown in FIG. 10 or radiates by ways of a gap 32 on a ground plate 31, wherein when the antenna 30 radiates by ways of the gap 32 on the ground plate 31, a microstrip 33 (or a main antenna) or other feed line on the other side of the substrate feeds to the antenna 30.

As illustrated in FIG. 6, in another embodiment, the canvas 20 has a first layer 23 on a front side of the first face 21, and the canvas 20 has a second layer 24 attached on a back side of the first layer 23, the antenna 30 is fixed on the back side of the first layer 23 and between the first layer 23 and the second layer 24. The antenna 30 is made of the conductive material and is printed on the back side of the first layer 23. In another embodiment, the antenna 30 is composed with or is fixed on the back side of the first layer 23 after being printing on a substrate.

The wireless communication module 40 is mounted on the protective frame 10 (such as on a groove 11 of a back surface of the protective frame 10), as shown in FIGS. 1 and 2, and the wireless communication module 40 is retained in the groove 11.

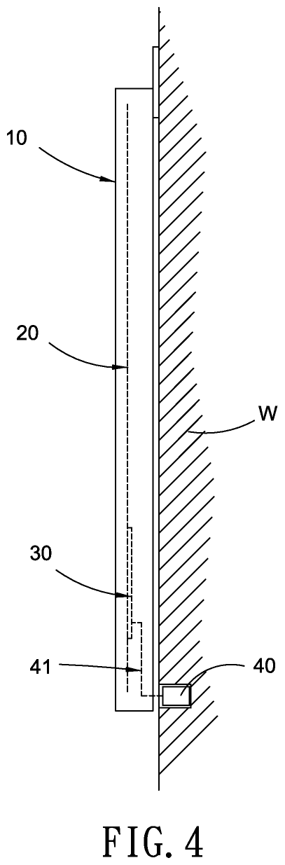

The antenna 30 is connected with the wireless communication module 40 directly (as shown in FIGS. 1, 2, 4, 6, and 8) or indirectly. For example, the wireless communication module 40 is connected with the antenna 30 via a wire 41, a cable or a flexible flat cable (FFC), wherein a first end of the wire 41 is connected with the antenna 30 by using conductive silver glue, and a second end of the wire 41 is connected with a connector 42, as shown in FIG. 4, such that the antenna 30 is in connected with the wireless communication module 40 by ways of the connector 42 of the wire 41. With reference to FIG. 6, the canvas 20 has an opening 241 formed on the second layer 24 so that the wireless communication module 40 is connected with the antenna 30 by using the wire 41 passing through the opening 241 and the antenna 30. Referring to FIG. 8, the contacting plate 13 has a window 131, and the wireless communication module 40 is connected with the antenna 30 by using the wire 41 passing through the window 131 and the antenna 30.

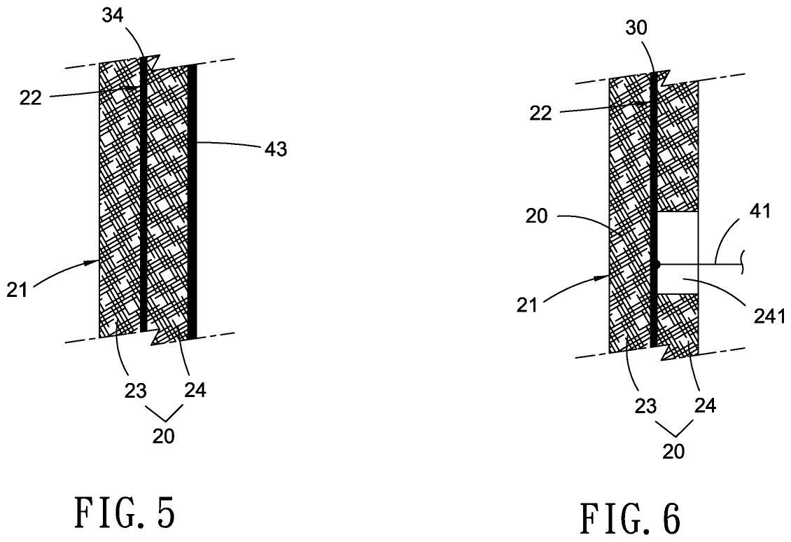

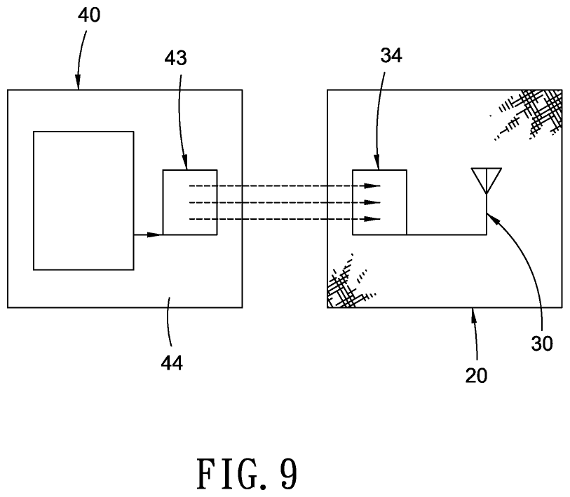

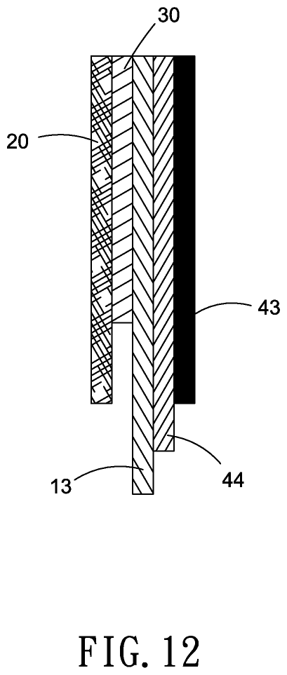

Referring to FIGS. 5, 7, and 9, the antenna 30 is connected with the wireless communication module 40 indirectly, the antenna 30 includes a first surround portion 34, and the wireless communication module 40 includes a second surround portion 43 stacked and coupled with the first surround portion 34. The second surround portion 43 is formed on the contacting plate 13, as shown in FIG. 7. In another embodiment, the second surround portion 43 is arranged on a hold plate 44 of the wireless communication module 40 or a printed circuit board (PCB), wherein the wireless communication module 40 is fixed adjacent to the back face 22 of the canvas 20 upright (as shown in FIG. 11) or upside down (as illustrated in FIG. 12), and the first surround portion 34 senses with the second surround portion 43 so that the antenna 30 is connected with the wireless communication module 40 indirectly, for example, the wireless communication module 40 couples and feeds with the antenna 30 by ways of a magnetic field between the first surround portion 34 and the second surround portion 43, wherein at least one antenna 30 is printed based on using requirements or the first face 21 of the canvas 20 (or a drawing paper) is configured to be drawn, the antenna 30 is hidden on the back face 22 of the canvas 20, such that the first face 21 of the canvas 20 has the antenna 30 and the wireless communication module 40.

The wireless communication module 40 is any one of an access point (AP) Wi-Fi module, a router Wi-Fi module, a Bluetooth module, radio frequency identification (RFID) reader, a radio frequency identification (RFID) tag module, and a mobile communication module. For instance, the wireless communication module 40 is double frequency access point (AP) Wi-Fi module having antenna port of 4G/5G, wherein the wireless communication module 40 includes a 2T/2R MIMO antenna, the back face 22 of the canvas 20 has four sets of antennas 30 printed thereon and connected with a connection port of the 2T/2R MIMO antenna via the wire 41, wherein 2.4 GHz to 2.5 GHz is Industrial Scientific Medical (ISM) band applicable for industrial, scientific, and medical mechanisms.

The wireless communication module 40 is any one of the Bluetooth module, the RFID reader, and the RFID tag module so as to be applicable for Internet of Things (IoT) sensing, wherein a mobile communication module (such as 4G module) is a wireless communication module applicable for a LTE micro base station so as to expand indoor coverage of LTE network.

In application, a copy painting with the antennas 30 and the protective frame 10 in which the wireless communication module 40 is built in are sold. In another application, at least one the antennas 30 is printed on the canvas 20 (or the drawing paper), and the canvas 20 is sold independently or with the protective frame 10 having the wireless communication module 40. Preferably, patterns are drawn or printed on the canvas 20, and the protective frame 10 is fixed on a desired position so that the antennas 30 is connected with the Wi-Fi wireless base station 50 (as shown in FIG. 30) or is connected with the wireless communication module 40 built in the protective frame 10 so as to be used as a hidden wireless router, such as Wi-Fi router, the access point (AP) Wi-Fi module, the IoT sensing or mobile communication base station.

Referring to FIG. 4, the wireless communication module 40 is built into a networked line, an information line, and a power line of a wall W, and a painting having the antennas 30 (inclusive of the protective frame 10 and the canvas 20) is hung on the wall, the wire 41 is connected with the wireless communication module 40 and the antennas 30, thus producing the hidden Wi-Fi router, the access point (AP) Wi-Fi wireless base station, the IoT sensing or the mobile communication base station.

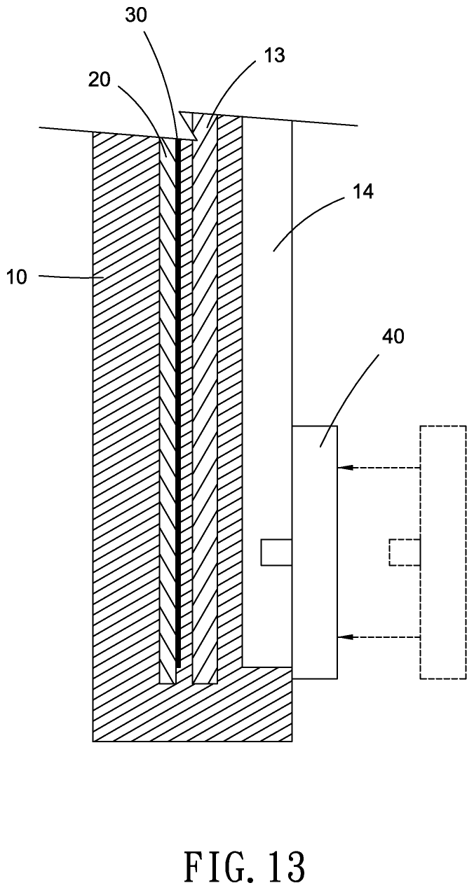

With reference to FIG. 13, a height difference is defined between the contacting plate 13 and the protective frame 10, wherein the contacting plate 13 has an accommodation space 14 for accommodating the wireless communication module 40 upside down, wherein the wireless communication module 40 is a desktop device (such as a desktop access point (AP) Wi-Fi wireless base station), and the antennas 30 is connected with the desktop AP Wi-Fi wireless base station via the wire 41 and the connector 42.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A picture frame structure for supporting wireless network communication comprising:
a protective frame;
a canvas fixed on the protective frame;
an antenna; and
an wireless communication module;
wherein the antenna is made of conductive material and is printed on the canvas, and the conductive material of the antenna penetrates into the canvas;
wherein the wireless communication module and the antenna are connected so as to wirelessly communicate with the antenna.

2. The picture frame structure as claimed in claim 1, wherein the wireless communication module is any one of an access point (AP) Wi-Fi module, a router Wi-Fi module, a Bluetooth module, radio frequency identification (RFID) reader, a radio frequency identification (RFID) tag module, and a mobile communication module.

3. The picture frame structure as claimed in claim 1, wherein the antenna is printed on a back face of the canvas.

4. The picture frame structure as claimed in claim 3, wherein the wireless communication module is mounted on a groove of a back surface of the protective frame.

5. The picture frame structure as claimed in claim 4, wherein the wireless communication module is connected with the antenna via a wire.

6. The picture frame structure as claimed in claim 3, wherein the protective frame includes a contacting plate located on a back surface of the canvas, and the antenna is defined between the back face of the canvas and the contacting plate.

7. The picture frame structure as claimed in claim 6, wherein the contacting plate has a window, and the wireless communication module is connected with the antenna by using a wire passing through the window and the antenna.

8. The picture frame structure as claimed in claim 1, wherein the antenna includes a first surround portion printed on a back face of the canvas, and the wireless communication module includes a second surround portion stacked and coupled with the first surround portion.

9. The picture frame structure as claimed in claim 6, wherein a height difference is defined between the contacting plate and the protective frame, wherein the contacting plate has an accommodation space for accommodating the wireless communication module upside down, wherein the wireless communication module is a desktop device.

10. The picture frame structure as claimed in claim 1, wherein the canvas has a first layer on a front side of the first face, and the canvas has a second layer attached on a back side of the first layer, the antenna is printed on the back side of the first layer and between the first layer and the second layer.

11. The picture frame structure as claimed in claim 10, wherein the canvas has an opening formed on the second layer so that the wireless communication module is connected with the antenna by using a wire passing through the opening and the antenna.

12. The picture frame structure as claimed in claim 10, wherein the antenna includes a first surround portion, and the wireless communication module includes a second surround portion stacked and coupled with the first surround portion.

13. A picture frame structure for supporting wireless network communication comprising:
a protective frame;
a canvas fixed on the protective frame;
an antenna; and
an wireless communication module;
wherein after the antenna is printed on a substrate, the antenna is connected with the canvas; and
wherein the wireless communication module and the antenna are connected so as to wirelessly communicate with the antenna.

14. The picture frame structure as claimed in claim 13, wherein the wireless communication module is any one of an access point (AP) Wi-Fi module, a router Wi-Fi module, a Bluetooth module, radio frequency identification (RFID) reader, a radio frequency identification (RFID) tag module, and a mobile communication module.

15. The picture frame structure as claimed in claim 13, wherein the antenna is printed on a back face of the canvas.

16. The picture frame structure as claimed in claim 13, wherein the wireless communication module is mounted on a groove of a back surface of the protective frame.

17. The picture frame structure as claimed in claim 13, wherein the antenna radiates by ways of a gap on a ground plate.

18. The picture frame structure as claimed in claim 13, wherein the protective frame includes a contacting plate located on a back surface of the canvas, and the antenna is defined between the back face of the canvas and the contacting plate.

19. The picture frame structure as claimed in claim 18, wherein the contacting plate has a window, and the wireless communication module is connected with the antenna by using a wire passing through the window and the antenna.

20. The picture frame structure as claimed in claim 18, wherein the antenna includes a first surround portion, and the wireless communication module includes a second surround portion stacked and coupled with the first surround portion.

21. The picture frame structure as claimed in claim 18, wherein a height difference is defined between the contacting plate and the protective frame, wherein the contacting plate has an accommodation space for accommodating the wireless communication module upside down, wherein the wireless communication module is a desktop device.

22. The picture frame structure as claimed in claim 13, wherein the canvas has a first layer on a front side of the first face, and the canvas has a second layer attached on a back side of the first layer, the antenna is printed on the back side of the first layer and between the first layer and the second layer.

23. The picture frame structure as claimed in claim 22, wherein the contacting plate has a window, and the wireless communication module is connected with the antenna by using a wire passing through the window and the antenna.

24. The picture frame structure as claimed in claim 22, wherein the antenna includes a first surround portion, and the wireless communication module includes a second surround portion stacked and coupled with the first surround portion.
